(19) United States
(12) Patent Application Publication
(10) Pub. No.: US 2006/0114586 A1
(43) Pub. Date: Jun. 1, 2006

(54) Magnetic transfer apparatus

(75) Inventors: Kazunori Komatsu, Odawara-shi (JP); Minoru Araki, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/262,888

(22) Filed: Nov. 1, 2005

(30) Foreign Application Priority Data
Nov. 19, 2004 (JP) 2004-336700

(51) Int. Cl. G11B 5/86

(52) U.S. Cl. 360/17; 360/15

(57) ABSTRACT

A magnetic transfer apparatus, comprising: a transferable magnetic field application device which, in a state in which a transferee disk whose magnetic layer has undergone initial magnetization in one direction of concentric tracks and a master disk having on the surface a patterned magnetic layer for transferring information to the magnetic layer of said transferee disk are kept in tight contact with each other, integrally turns said transferee disk and master disk relative to said transferable magnetic field, while applying a transferable magnetic field in the direction reverse to the direction of said initial magnetization, to magnetically transfer said information to the magnetic layer of said transferee disk, wherein said transferable magnetic field application device is so configured as to increase the applied magnetic field intensity from the inner circumference toward the outer circumference of said transferee disk.

### BACKGROUND OF THE INVENTION

1. Field of the Invention

The present invention relates to a magnetic transfer apparatus, and more particularly to a magnetic transfer apparatus for magnetically transferring information from a master disk, on which information to be transferred is formed in a patterned shape, to a transferee magnetic disk, which is a magnetic recording medium.

2. Description of the Related Art

Magnetic disks, which are high-density magnetic recording media for use in hard disk apparatus, flexible disk apparatuses and the like, are now being further improved to make possible faster access and provide greater capacities for information recording.

To achieve this capacity increase, the track width is narrowed, and so-called tracking servo techniques for accurately scanning the magnetic head within this reduced track width have come to play a vital role.

On a magnetic disk, a servo signal for tracking use, an address information signal, a regenerated clock signal and so forth are pre-formatted at prescribed intervals for the tracking servo purpose.

As a way to accomplish this pre-formatting accurately and efficiently in a short period of time, the present applicant proposed a magnetic transfer method by which a master disk having a magnetic layer of a convexo-concave pattern matching the information to be transferred to a transferee disk (hereinafter referred to as slave disk), which is to be a high-density magnetic recording medium is made ready, the magnetic layer of the slave disk is initially magnetized in advance in one direction of the track, and subsequently a transferring magnetic field is applied in a direction substantially inverse to the direction of initial magnetization in a state in which this initially magnetized slave disk and the master disk are kept in tight contact with each other (see Japanese Patent Application Laid-Open No. 2001-014667 for instance).

In this case, the optimal intensity of the initial DC magnetic field to be applied for the initial magnetization of the magnetic layer of the slave disk is more about double the coercive force Hc of the magnetic layer of the slave disk and the optimal intensity of the magnetic field for the transfer, about equal to the coercive force Hc of the magnetic layer of the slave disk.

### SUMMARY OF THE INVENTION

Incidentally, since inner tracks of the slave disk used according to the magnetic transfer method described in Japanese Patent Application Laid-Open No. 2001-014667 are smaller in the radius of curvature, they are subject to a magnetic field deviating from the tangential direction of the tracks and, accordingly, the transfer magnetization would be disturbed by an excessive intensity of the magnetic field that is applied, it is necessary to set an optimal intensity for the inner tracks of the slave disk.

Also, this magnetic transfer method has a characteristic that, while the smaller the bit length of the magnetic pattern, the superior the transfer performance, at a greater bit length the transferred magnetization pattern may be disturbed if the intensity of the applied magnetic field is too low.

Therefore it involves a problem that, where the magnetic field intensity is set to be optimal for the inner tracks of the slave disk, accurate transferring of the magnetization pattern is increasingly more difficult to outer tracks than to inner tracks of the slave disk.

An object of the present invention, attempted in view of these circumstances, is to provide a magnetic transfer apparatus permitting satisfactory magnetic transfers, relatively free from disturbances in magnetization pattern, to all the tracks, from the innermost to the outermost, of a slave disk having undergone initial magnetization when the magnetic pattern of a master disk is to be transferred to it.

In order to achieve the object stated above, a magnetic transfer apparatus of the present invention comprises: a transferable magnetic field application device which, in a state in which a transferee disk whose magnetic layer has undergone initial magnetization in one direction of concentric tracks and a master disk having on the surface a patterned magnetic layer for transferring information to the magnetic layer of said transferee disk are kept in tight contact with each other, integrally turns said transferee disk and master disk relative to said transferable magnetic field, while applying a transferable magnetic field in the direction reverse to the direction of said initial magnetization, to magnetically transfer said-information to the magnetic layer of said transferee disk,

wherein said transferable magnetic field application device is so configured as to increase the applied magnetic field intensity from the inner circumference toward the outer circumference of said transferee disk.

In the magnetic transfer apparatus according to the invention, the intensity of the magnetic field to be applied to the outermost track on the surface of the transferee disk is not less than 1.01 times but not more than 1.2 times the intensity of the transferable magnetic field to be applied to the innermost track.

Also, in the magnetic transfer apparatus according to the invention, the intensity of the magnetic field to be applied to the innermost track on the surface of the transferee disk is not less than 0.6 times but not more than 1.3 times the coercive force of the magnetic layer of the transferee disk.

According to the invention, as the transferable magnetic field application device is so configured as to increase the applied magnetic field intensity from the inner circumference toward the outer circumference of the transferee disk, disturbances in magnetization pattern can be suppressed even on outer tracks of the transferee disk where the bit length is greater than on inner tracks, resulting in satisfactory magnetic transfers.

Further, as the intensity of the magnetic field to be applied to the outermost track on the surface of the transferee disk is set to be not less than 1.01 times but not more than 1.2 times the intensity of the magnetic field to be applied to the innermost track, the transferred magnetization pattern can be prevented from being disturbed even on the outermost track on the surface of the transferee disk, enabling the magnetization pattern to be transferred accurately.

Furthermore, as the intensity of the magnetic field to be applied to the innermost track on the surface of the transferee disk is set to be not less than 0.6 times but not more than 1.3 times the coercive force of the magnetic layer of the transferee disk, the intensity of the magnetic field is optimized for the innermost track whose radius of curvature is smaller, enabling the magnetization pattern to be transferred accurately.

As described above, in the magnetic transfer apparatus according to the invention, as it is so configured that the intensity of the magnetic field applied is greater on outer tracks of the transferee disk when the magnetic pattern of the master disk is to be transferred to the slave disk having undergone initial magnetization, satisfactory magnetic transfers to all the tracks, from the innermost to the outermost, can be achieved, relatively free from disturbances in magnetization pattern.

### BRIEF DESCRIPTION OF THE DRAWINGS

FIG. 1 is a perspective view showing the initial magnetization device of a magnetic transfer apparatus, which is a preferred embodiment of the present invention;

FIG. 2 is a perspective view showing the transferable magnetic field application device of the magnetic transfer apparatus, which is the preferred embodiment of the invention;

FIG. 3 is a perspective view illustrating a holder.

FIGS. 4A, 4B and 4C are a plan, profile and magnetic field intensity distribution diagram, respectively, illustrating the transferable magnetic field;

FIGS. 5A, 5B and 5C are conceptual diagrams of the process of magnetic transfer;

FIG. 6 shows the result of simulation of a magnetic flux; and

FIGS. 7A, 7B and 7C are graphs illustrating sub-peaks of reproduced signals.

### DETAILED DESCRIPTION OF THE PREFERRED EMBODIMENTS

A magnetic transfer apparatus, which is a preferred embodiment of the present invention, will be described in detail below with reference to accompanying drawings. In the drawings, the same constituent members are designated by respectively the same numerals or signs.

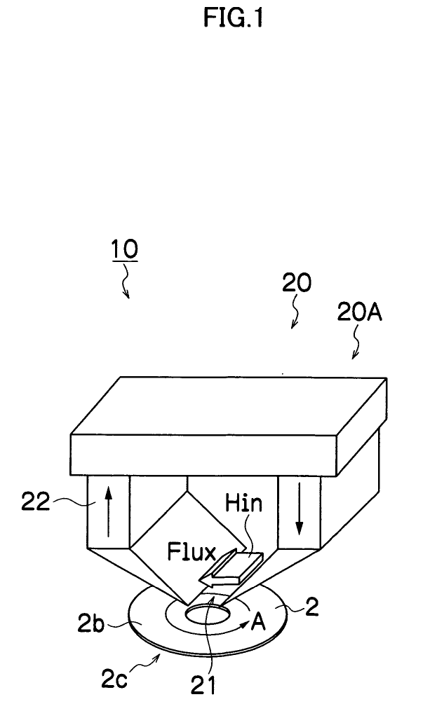

FIG. 1 is a perspective view showing the principal part of an initial magnetization device for initially magnetizing a slave disk, which is the transferee disk. An initial magnetization device 20 constituting part of a magnetic transfer apparatus 10, comprises a chuck stage (not shown) which turns mounted with a slave disk 2, a magnet 20A and so forth. An electromagnet is used as the magnet 20A, which comprises at least a core 22 provided with heads having between them a gap 21 extending from the innermost track to the outermost track of the slave disk 2 and a coil (not shown) wound around the core.

A DC magnetic field is generated by supplying power to the coil, and the chuck stage turns in the direction of arrow A shown in FIG. 1 to magnetize the whole areas of magnetic layers 2b and 2c of the slave disk 2 in one direction. The direction of applying the DC magnetic field to the slave disk 2 is along the track as shown in FIG. 1, and a magnetic field Hin is generated by the magnet 20A in the inter-head gap 21 of the core 22. Although an electromagnet is used here as the magnet 20A, a permanent magnet may as well be used.

It is preferable for the initial DC magnetic field Hin to be about double the coercive force Hc of the magnetic layer 2b and 2c of the upper and lower faces of the slave disk 2. To meet this requirement, the width of the gap 21 of the magnet 20A is kept no more than a half of the radius of the innermost-track of the slave disk 2 in this embodiment of the invention to bring the distance between the gap 21 and the magnetic layer 2b of the slave disk 2 close to 10 mm or less, preferably 5 mm or less, or even more preferably to 3 mm or less. For instance, where the radius of the innermost track is 4.7 mm, the width of the gap 21 is kept at 2.3 mm or less, and the distance between the gap 21 and the magnetic layer 2b of the slave disk 2 is kept at 3 mm or less.

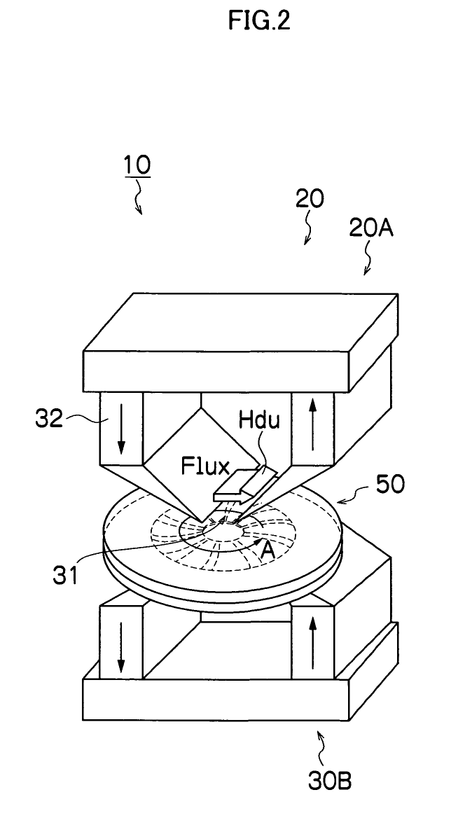

FIG. 2 is a perspective view showing the principal part of a transferable magnetic field-application device which applies a transferable magnetic field for magnetically transferring information magnetically recorded on master disks to the slave disk 2. A transferable magnetic field application device 30 constituting part of the magnetic transfer apparatus 10 comprises a holder pair 50 for holding the slave disk 2 and the master disks in a state of tight contact with each other, magnets 30A and 30B arranged above and underneath the holder pair 50, and a turning device (not shown) for supporting the holder pair 50 and turning the holder pair 50 in the direction of arrow A relative to the magnets 30A and 30B in the drawing.

An electromagnet is used as the magnet 30A. As shown in FIG. 2, it comprises at least a core 32 provided with a head constituting a gap 31 extending in the radial direction from the innermost track to the outermost track of the slave disk 2 and a coil (not shown) wound around the core 32. The magnet 30B is configured in the same way.

A DC magnetic field is generated by supplying power to the coil, and the turning device (not shown) turns the holder pair 50 in the direction of arrow A shown in FIG. 2 to transfer information recorded on the master disks to the whole area of the slave disk 2. Incidentally, though electromagnets are used here for both the magnet 30A and the magnet 30B, they may as well be permanent magnets.

Although the magnet 30A and the magnet 30B are arranged above and underneath the holder pair 50 in this embodiment because the configuration is made so that the slave disk 2 is sandwiched between two master disks and information recorded on the master disks is transferred to the upper and lower faces of the slave disk 2, it is also conceivable, where only one master disk is used and magnetic information is transferred to only the upper or lower face of the slave disk 2, to arrange that master disk on either side of the holder pair 50.

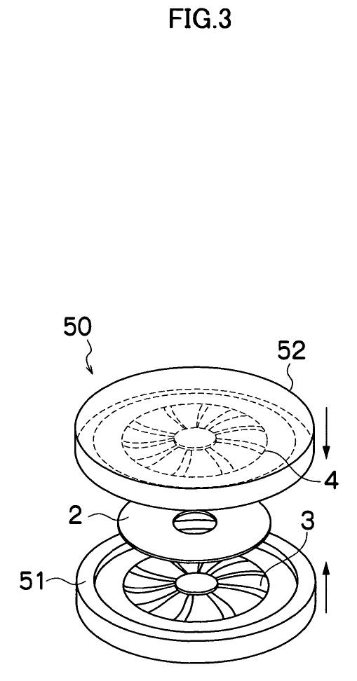

The holder pair 50 comprises a lower holder 51, an upper holder 52 and so forth as shown in FIG. 3. The slave disk 2, in a state in which its lower face magnetic layer 2c is tightly stuck to the upper face magnetic layer of a master disk 3 and its upper face magnetic layer 2b is tightly stuck to the lower face magnetic layer of a master disk 4, is held between the lower holder 51 and the upper holder 52. Transferable magnetic fields are applied to the slave disk 2 in this state from both the upper and lower faces of the holder pair 50, and magnetic information including servo signals recorded on the master disks 3 and 4 is transferred to both the upper and lower faces of the slave disk 2.

The direction of the magnetic field transfer to the slave disk 2, as shown in FIG. 2, is such-that the magnet 30A generates a magnetic field Hdu in the inter-head gap 31 of the core 32 in the tracking direction reverse to the direction of the initial magnetization. The same applies to the magnet 30B.

It is preferable for the intensity of the transferable magnetic field Hdu to be 0.6 to 1.3 times the coercive force Hc of the magnetic layer 2b and 2c of the upper and lower faces of the slave disk 2, more preferably 0.8 to 1.2 times the same, and even more preferably 1 to 1.1 times the same.

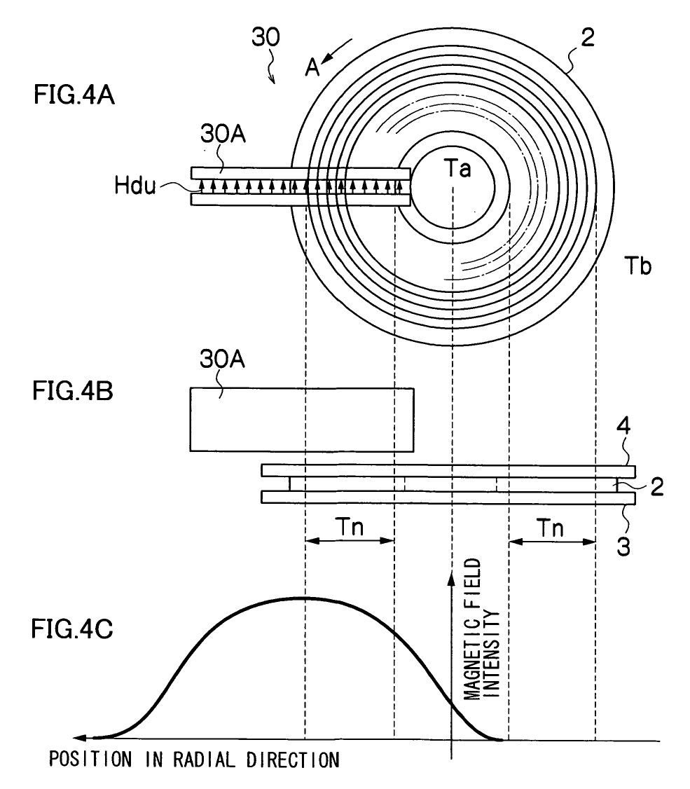

FIGS. 4A, 4B and 4C illustrate the intensity distribution of the magnetic field Hdu applied by the magnet 30A relative to the position in the radial direction of the slave disk 2 when the magnetic patterns recorded on the master disks 3 and 4 are transferred to the magnetic layer 2b and 2c of the upper and lower faces of the slave disk 2.

FIG. 4A is a plan, FIG. 4B, a profile, and FIG. 4C, a diagram of the intensity distribution of the magnetic field Hdu relative to the position in the radial direction. The magnet 30A is so arranged as to cover the whole tracking area Tn on the surface of the slave disk 2 from the innermost track Ta to the outermost track Tb.

The magnet 30A is arranged in a position protruding out of the outer circumference of the slave disk 2 as shown in FIGS. 4A and 4B so that the intensity of the applied magnetic field Hdu gradually increases from the innermost track Ta to the outermost track Tb on the surface of the slave disk 2.

Incidentally, instead of arranging the magnet 30A in this way, the number of coil windings of the magnet 30A may be varied correspondingly in the radial direction of the slave disk 2. Or the magnet 30A may be inclined on the vertical plane to bring the distance of the core 32 to the surface of the slave disk 2 gradually closer to the outer circumference of the slave disk 2. Alternatively, the gap 31 of the core 32 may be gradually narrowed toward the outer circumference of the slave disk 2.

Incidentally, though FIG. 4 makes no mention of the magnet 30B, what applies to the magnet 30A exactly holds true of the magnet 30B. It is so configured that the intensity of the applied magnetic field Hdu gradually increases from the innermost track Ta to the outermost track Tb on the surface of the slave disk 2.

Next, the magnetic transfer method and the transfer mechanism by which the magnetic patterns of the master disk 3 are transferred to the magnetic layer 2c of the slave disk 2 will be described.

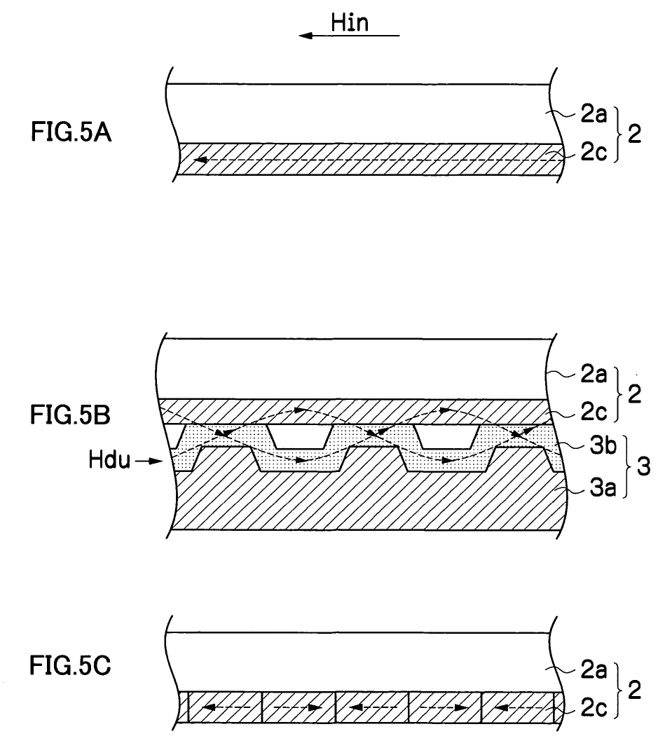

FIGS. 5A, 5B and 5C illustrate the process of magnetic transfer. In FIGS. 5A, 5B and 5C, the illustration of the magnetic layer 2b on the upper side of the slave disk 2 is dispensed with, and only the transfer to the magnetic layer 2c on the lower side is shown with a view to simplifying the illustration and description.

First, the slave disk 2 is subjected to initial magnetization as shown in FIG. 5A. The initial magnetization is accomplished by fixing the slave disk 2 to the chuck stage (not shown) of the initial magnetization device 20 as shown in FIG. 1, and causing the magnet 20A to generate the initial DC magnetic field Hin in one direction along a tangent to the track. Along with that, the chuck stage is turned by one round or more relative to the magnet 20A to apply the initial DC magnetic field to the whole track areas of the magnetic layers 2b and 2c of the slave disk 2.

Incidentally, the initial magnetization of the slave disk 2 may be accomplished at the same time for both the magnetic layers 2b and 2c of the upper and lower faces of the slave disk 2 or separately for one face at a time.

Then, the upper and lower faces of the slave disk 2 having undergone initial magnetization are brought into tight contact with the master disks 3 and 4 and held between the holder pair 50, and further caused to be held by the turning device (not shown) of the transferable magnetic field application device 30.

Then, the magnetic field Hdu in the direction reverse to that of the initial magnetization is generated by the magnets 30A and 30B, the holder pair 50 is turned by one round or more relative to the magnets 30A and 30B to apply the transferable magnetic field to the whole area of the track, and the information recorded on the master disks 3 and 4 as magnetic patterns is magnetically transferred to the upper and lower faces of the slave disk 2.

This transfer mechanism functions in the following manner. Thus, magnetic information is formed as a convexo-concave magnetic layer pattern on the magnetic layer 3b of the master disk 3 as shown in FIG. 5B. As a magnetic field more intense than the transferable magnetic field Hdu is applied to the surface of the magnetic layer 2c of the slave disk 2 which does not come into contact with this magnetic layer 3b of the master disk 3, when the transferred magnetic field surpasses the coercive force Hc of the magnetic layer 2c of the slave disk 2, the magnetization in that part is inverted.

On the other hand, in the magnetic layer 2c of the slave disk 2 in contact with the magnetic layer 3b of the master disk 3, the transferable magnetic field Hdu concentrates on the magnetic layer 3b of the master disk 3. Thus the transferred magnetic field is in a shielded state at the concentrated portion. As a result, since only a magnetic field far weaker than the transferable magnetic field Hdu is applied to the magnetic layer 2c of the slave disk 2, the magnetization of the slave disk 2 remains in the direction of the initial magnetization unaffected by the transferable magnetic field Hdu, and is in the state of magnetization shown in FIG. 5C. This causes patterned magnetic information formed on the magnetic layer 3b of the master disk 3 to be transferred to and magnetically recorded on the magnetic layer 2c of the slave disk 2.

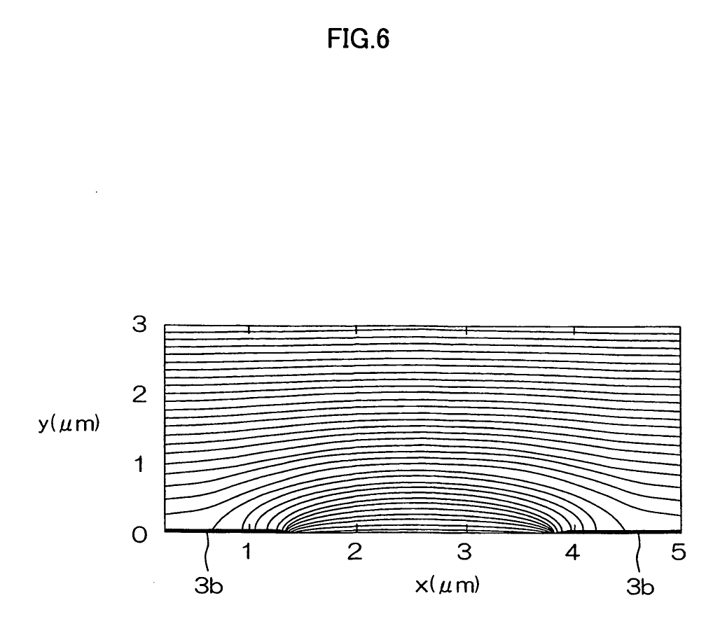

Next, the transferring characteristics of such magnetic transfers will be described below. FIG. 6 shows the result of simulation of the magnetic flux in the vicinity of the magnetic layer 3b of the master disk 3. As shown in FIG. 6, more of the transferred magnetic field enters into end parts of the magnetic layer 3b of the master disk 3. As a result, the transferred magnetic field is stronger in the end pats of the magnetic layer, and weaker in the central part between bits, where it is not in contact with the magnetic layer 3b of the master disk 3.

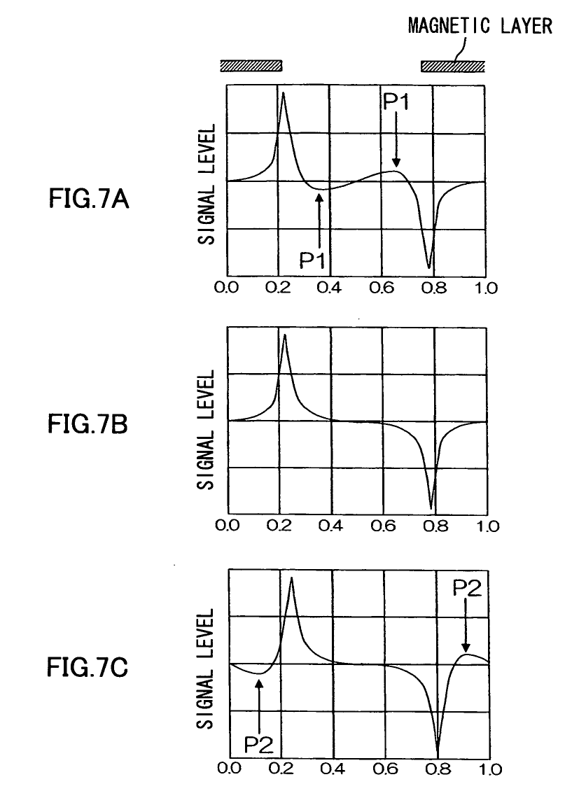

For this reason, where the transferred magnetic field is too small, magnetization can be inverted only in part of the magnetic layer 2c of the slave disk 2 which is not in contact with the magnetic layer 3b. FIGS. 7A, 7B and 7C show signals reproduced by the magnetic head magnetically transferred to the slave disk 2. Where magnetization can be inverted only in part of the magnetic layer 2c of the slave disk 2, the initial magnetization remains in the central part between bits, and small sub-peaks P1 appear in the signals reproduced by the magnetic head elsewhere than the pattern on the master disk 3 as shown in FIG. 7A. This phenomenon is more apt to occur where bit length is greater.

Conversely, where the transferred magnetic field is too strong, the transferred magnetic field overflows the bits in contact with the magnetic layer 3b of the master disk 3 as shown in FIG. 7C, and sub-peaks P2 occur similarly. Neither of these sub-peaks P1 and P2 appears where the intensity of the transferred magnetic field is appropriate as shown in FIG. 7B.

For this reason, the transfer apparatus 10 according to the invention, an appropriate transferable magnetic field Hdu is applied to the innermost track Ta of the slave disk 2 and the intensity of the transferable magnetic field Hdu is increased toward the outermost track Tb as shown in FIGS. 4A, 4B and 4C since the bit length increases in that direction.

In practice, it is preferable for the intensity of the transferable magnetic field to be applied to the innermost track to be 0.6 to 1.3 times the coercive force of the magnetic layer of the transferee disk and that of the intensity of the transferable magnetic field to be applied to the outermost track Tb to be 1.01 to 1.2 times the intensity of the transferable magnetic field to be applied to the innermost track Ta, more preferably 1.02 to 1.15 times, and even more preferably 1.04 to 1.1 times.

Since the magnetic transfer apparatus 10 according to the invention is configured in this way, appropriate inversion of magnetization takes place over the whole tracking area Tn, and no sub-peaks P1 or P2 emerge in the signals reproduced by the magnetic head elsewhere than the pattern on the master disk 3, and magnetic information recorded on the master disk 3 can be accurately transferred to the slave disk 2.

Although this magnetic transfer apparatus 10 embodying the invention has been described with respect to a configuration in which the slave disk 2 and the master disks 3 and 4 are held horizontally, they need not be held horizontally, but can as well be held vertically or inclined by a prescribed angle relative to the horizontal direction.

What is claimed is:

1. A magnetic transfer apparatus, comprising:
a transferable magnetic field application device which, in a state in which a transferee disk whose magnetic layer has undergone initial magnetization in one direction of concentric tracks and a master disk having on the surface a patterned magnetic layer for transferring information to the magnetic layer of said transferee disk are kept in tight contact with each other, integrally turns said transferee disk and master disk relative to said transferable magnetic field, while applying a transferable magnetic field in the direction reverse to the direction of said initial magnetization, to magnetically transfer said information to the magnetic layer of said transferee disk,
wherein said transferable magnetic field application device is so configured as to increase the applied magnetic field intensity from the inner circumference toward the outer circumference of said transferee disk.

2. The magnetic transfer apparatus according to claim 1, wherein the intensity of the magnetic field to be applied to the outermost track on the surface of said transferee disk is not less than 1.01 times but not more than 1.2 times the intensity of the transferable magnetic field to be applied to the innermost track.

3. The magnetic transfer apparatus according to claim 1, wherein the intensity of the magnetic field to be applied to the innermost track on the surface of said transferee disk is not less than 0.6 times but not more than 1.3 times the coercive force of the magnetic layer of said transferee disk.

4. The magnetic transfer apparatus according to claim 2, wherein the intensity of the magnetic field to be applied to the innermost track on the surface of said transferee disk is not less than 0.6 times but not more than 1.3 times the coercive force of the magnetic layer of said transferee disk.
